(19) United States
(12) Patent Application Publication
(10) Pub. No.: US 2016/0222751 A1
(43) Pub. Date: Aug. 4, 2016

(54) Self-Lubricating Seal Element for Rotating Control Device

(71) Applicant: HALLIBURTON ENERGY SERVICES, INC., Houston, TX (US)

(72) Inventors: Raymond Ronald Bullock, Hoveton (GB); Lee J. Hall, The Woodlands, TX (US)

(73) Assignee: Halliburton Energy Services, Inc., Houston, TX (US)

(21) Appl. No.: 15/021,623

(22) PCT Filed: Nov. 27, 2013
(86) PCT No.: PCT/US2013/072284

§ 371 Date: Mar. 11, 2016

(51) Int. Cl. E21B 33/08; B29C 67/24; F16J 15/16; E21B 3/02; E21B 21/00

(52) U.S. Cl. CPC E21B 33/085; E21B 3/02; E21B 21/00; F16J 15/162; B29C 67/24; B29K 2507/04

(57) ABSTRACT

Methods for making and using a seal element for a rotating control device used in rotary drilling systems are disclosed. In an example embodiment, the seal element has a bore, a base region, and a nose region. The method comprises providing a mold for the seal element for the rotating control device, adding at least one self-lubricating component to a liquid elastomer, placing the liquid elastomer material having self-lubricating component into the mold, heating the combined elastomer and self-lubricating component in the mold, forming a seal element having a bore, wherein a mixture of the self-lubricating component and the liquid elastomer is adjacent to at least an inner circumferential surface of the longitudinal bore of the seal element.

### TECHNICAL FIELD

This disclosure relates generally to a seal element for a rotating control device (RCD) used in rotary drilling systems, and particularly to a self-lubricating seal element for the RCD.

### BACKGROUND

During drilling, an earth-boring drill bit is typically mounted on the lower end of a drill string and is rotated to form a wellbore by rotating the drill bit, such as by rotating the drill string and/or rotating the drill bit relative to the drill string using a downhole motor. During this process erratic pressures and uncontrolled flow known as formation “kick” pressure surges can emanate from a well reservoir, potentially causing a catastrophic blowout. Because formation kicks are unpredictable and would otherwise result in disaster, flow control devices known as blowout preventers (“BOPs”) are required on most wells drilled today. BOPs are often installed redundantly in stacks, and are used to seal, control and monitor oil and gas wells.

One common type of BOP is an annular blowout preventer. Annular BOPs are configured to seal the annular space between the drill string and the wellbore annulus. Annular BOPs are typically generally toroidal in shape and are configured to seal around a variety of drill string sizes, or alternatively around non-cylindrical objects such as a polygon-shaped Kelly drive. Drill strings formed of drill pipes connected by larger-diameter connectors can be threaded through an annular BOP. Annular BOPs are designed to maintain a seal around a stationary drill string. Rotating the drill string through an annular BOP would rapidly wear it out, causing the annular BOP to be less capable of sealing the well.

Closed annulus drilling operations include managed pressure drilling, underbalanced drilling, mud cap drilling, air drilling and mist drilling. A rotating control device (RCD), which may alternatively be referred to as a rotating drilling device, rotating drilling head, rotating flow diverter, pressure control device and rotating annular, may be located on top of the BOP stack, and is used to close the annulus while allowing rotation and reciprocation of the drill string in above hydrostatic pressure conditions within the closed annulus. During this type of drilling the wellbore/closed annulus is held at pressures that are well above atmospheric. The RCD forms a seal between the wellbore and the drill pipe so that the drill string can move vertically and rotationally without the loss of well pressure while continuing with all normal subterranean drilling operations including but not limited to drilling ahead, reaming, back reaming, tripping drill pipe, stripping drill pipe, rotating drill pipe and sliding drill pipe.

The key component in the RCD, which allows for the separation of high and low pressure regions, is the RCD seal element. The RCD seal element is comprised of a core and an elastomeric body. The core is molded into the upstream end of the elastomeric body and is used to fasten the element to the RCD. Cores can be made in many shapes and sizes and fabricated from many materials. For example, an RCD core can be made from steel and is referred to as a cage.

A drill string of varying diameter is passed through the center of an RCD seal element. RCD seal elements are currently made so that the inside diameter of the RCD seal element is smaller than the smallest outside diameter of any part of the drill string passing through it for the wellbore section to be drilled. As the various parts of the drill string move longitudinally through the interior of the stripper rubber, a seal is continuously maintained.

RCD seal elements seal around rough and irregular surfaces such as those found on a drill string and are subjected to conditions where strength and resistance to wear are very important characteristics. However, RCD seal elements often have a short life expectancy, especially when they are used in wells that have high wellbore and/or applied annulus pressures. Loads exerted on the outside of the element body by the high pressure region of the well cause the element to deform and press against the drill pipe. High frictional loads result from the pipe being stripped through the element as it is deformed against the drill pipe. High pressures in the well can accelerate RCD seal element failure. Common modes of RCD seal element failure include side wall blow through, vertical and horizontal cracking and chunking away of the interior region of the seal element body also known as “nibbing”.

Conventional prior art seal elements in rotating control devices (RCDs) tend to split or experience chunking when encountering harsh loading conditions due to poor tear resistance. Further, over time the seal element may become worn and may become unable to substantially deform to provide a seal around the drill string. Consequently, the seal element must be replaced, which may lead to down time during drilling operations that can be costly to a drilling operator.

### DESCRIPTION OF DRAWINGS

The details of one or more embodiments of the disclosure are set forth in the accompanying drawings and the description below.

FIG. 1 is an example drilling system with a rotating control device (RCD).

FIG. 2 is a partial cross-sectional view of an example RCD with dual seal elements.

FIG. 3A is a cross sectional view of an example RCD with a single seal element; FIG. 3B is a cross sectional view of the example RCD of FIG. 3A without housing; and FIG. 3C is a side view of the example seal element of FIG. 3B.

### DETAILED DESCRIPTION

This disclosure relates to an example seal element for a rotating control device (RCD). The seal element has self-lubricating properties and can create a seal between the drill pipe passed through the RCD and the interior of the wellbore below the RCD. In some embodiments, a lubrication medium can be provided to the seal element or packer/drill pipe interface by the incorporation of lubricating component additives such as, but not limited to, polarized graphite, to be embedded in the seal element or packer at the molding stage of the manufacturing process. The lubricating components can be subsequently released in operation as the interface is worn to reduce the coefficient of friction between the seal element or packer and drill pipe (or other tubular) thus reducing seal element or packer wear and providing extended operable life. As a result, drilling operations can be extended with reduced seal element degradation. Decreased seal element or packer wear leads to greater operational efficiency on site. With reduced wear, seal elements or packers are replaced less frequently thus saving considerable drilling rig lost time for replacing worn seal elements or packers.

This disclosure also relates to a method of improving the material properties of the elastomeric RCD seal element by introducing a self-lubricating material into the elastomer. In some implementations, the self-lubricating concept focuses on inclusion of solid-state lubricants into the elastomer formulation. As a RCD elastomer seal element undergoes wear during normal operations, it would be advantageous to have solid state lubricants incorporated into the material that would be deployed continuously in small doses as wear occurs. During the preparation of the elastomer raw material, self-lubricating components can be added so that the performance characteristics of the finished element are altered. RCD with self-lubricating seal elements can have reduced friction coefficient, improved resistance to wear and extended elongation.

Often RCD seal element life is short which can result in frequent element replacement during drilling operations. It is well-known that rig time can be very expensive, especially when drilling operations are performed in deep water. Typical deep water daily rig costs can range between $400,000 and $900,000 a day. If an RCD seal element can last for drilling a complete borehole section, the approximate two hours rig time for an element change out equates to a rig downtime saving of $33,000 to $75,000. Improving element life with an element with improved life and durability according to this disclosure will reduce to costs. This cost saving will be achieved by fewer elements being required to complete an operation, as well as saving in much more costly rig down time. Improving element life will also result in a reduction of nonproductive time for the rig since the rig must be shut down each time an element is changed out.

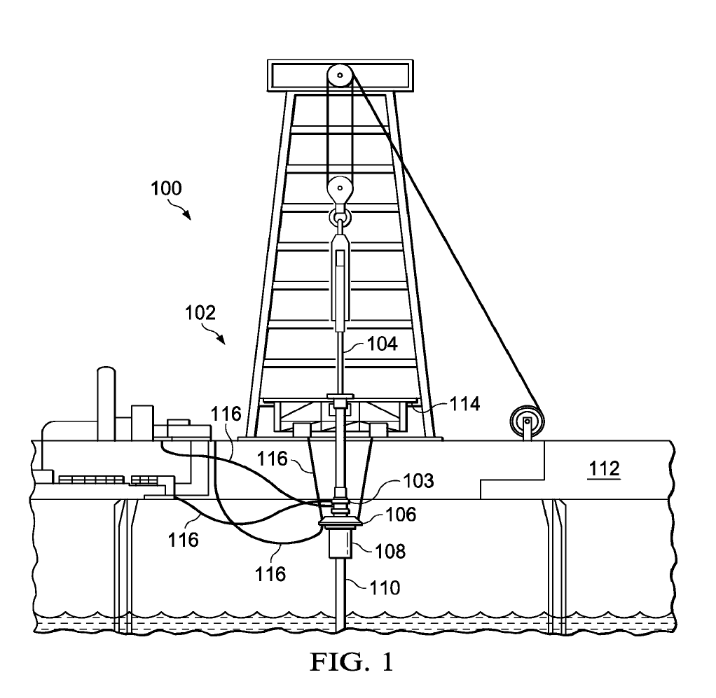

FIG. 1 illustrates an example drilling system configured to perform closed annulus drilling operations. During closed annulus drilling operations, also referred to as managed pressure drilling, underbalanced drilling, mud cap drilling, air drilling and mist drilling, the annulus of the drill string is closed off using a device referred to as a rotating control device (RCD), also commonly known as a rotating drilling device, a rotating drilling head, a rotating flow diverter, pressure control device or a rotating annular. The principle sealing mechanism of the RCD, referred to as a seal element (or a packer, stripper element, or stripper rubber), seals around the drill string, thus, closing the annulus around the drill string. During drilling operations, the seal element may experience wear that degrades the seal provided by the seal element. In order to minimize costly down time for the drilling system when replacing the seal element, lubricating components may be added in the seal element to lubricate the seal element and reduce wear, degradation and vibration associated with the seal element.

Drilling system 100 may include drilling unit 102, drill string 104, rotating control device (RCD) 106, sliding joint 108, and riser assembly 110. Drilling unit 102 may be any type of drilling system configured to perform drilling operations. Although FIG. 1 illustrates the use of RCD 106 from a floating drilling unit, those skilled in the art will understand that RCD 106 can be deployed from any type of onshore or offshore drilling unit including, but not limited to, semi submersible, drill ship, jack up, production platform, tension leg platform and land drilling units. In some implementations, including, but not limited to, land drilling units and jack up drilling units, a surface blowout preventer (BOP) stack may be incorporated into the drilling system. In these embodiments, RCD 106 may be coupled to a drilling annular incorporated in the BOP stack, an operations annular added to the BOP stack and drilling annular, or directly coupled to the BOP stack. In other implementations, RCD 106 may be coupled directly to a wellhead or casing head for drilling operations prior to the BOP stack being installed.

Drilling unit 102 may include rig floor 112 that is supported by several support structures (not expressly shown). Rotary table 114 may be located above rig floor 112 and may be coupled to drill string 104 in order to facilitate the drilling of a wellbore using a drill bit (not expressly shown) coupled to the opposite end of drill string 104. Drill string 104 may include several sections of tubular members with connecters at each end (e.g. drill pipe with connectors known in the art as “tool joints”) that communicate drilling fluid from drilling unit 102 and provide torque to the drill bit.

In the illustrated example, the drilling fluid may be circulated back to drilling unit 102 through riser assembly 110. In other implementations, such as a land drilling unit, the drilling fluid may be circulated through the wellbore or a casing included in the wellbore. Additionally, various cables 116 may couple RCD 106, slip joint 108, and riser assembly 110 to equipment on drilling unit 102.

In the illustrated example, drill string 104 may extend from drilling unit 102 through riser assembly 110 and into a subsea wellbore (not expressly shown) formed in the ocean floor. An upper portion of RCD 106 may be coupled to drilling unit 102 by an above RCD riser, tie back riser or telescoping joint, where the upper end of the riser or joint may be coupled to a drilling unit diverter housing (not expressly shown). A seal element or packer (not expressly shown) may be located within the body of RCD 106 and may be removed or inserted with the aid of latch assembly 103 integral, either internally or externally, to RCD 106. In some implementations, latch assembly 103 may include a hydraulic clamp that can be remotely controlled from drilling unit 102. A lower portion of RCD 106 may be coupled to sliding joint 108. In one example implementation, sliding joint 108 may be a telescoping joint that includes an inner barrel and an outer barrel that move relative to each other in order to allow offshore platform 102 to move during drilling operations without breaking drill string 104 and/or riser assembly 110. In other implementations, sliding joint 108 may be a multi-part sliding joint. Sliding joint 108 may be coupled to riser assembly 110, which provides a temporary extension of a subsea wellbore (not expressly shown) to offshore drilling unit 102.

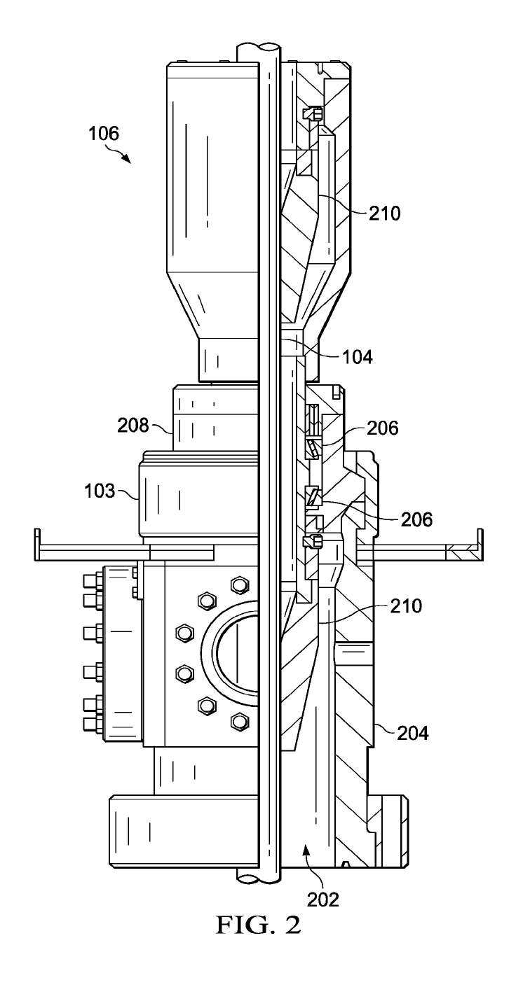

FIG. 2 illustrates a partial cross-sectional view of the example RCD 106 in FIG. 1. RCD 106 may be used to seal annulus 202 formed radially between body 204 of RCD 106 and drill string 104 positioned within body 204. RCD 106 may allow drill string 104 to rotate and enter and exit the wellbore while maintaining pressure in annulus 202. In the illustrated example, bearing assembly 206 may be located in bearing assembly housing 208. Seal element 210 may be positioned within body 204 of RCD 106 by a mandrel (not expressly shown) connected to bearing assembly 206 such that seal element 210 may rotate with drill string 104. In other implementations, RCD 106 may not include bearing assembly 206 such that seal element 210 remains stationary while drill string 104 rotates within RCD 106. Latch assembly 103 may be used to secure and release bearing assembly 206 and seal element 210 relative to body 204.

Seal element 210 may form a seal around drill string 104 (e.g., drill pipe and tool joints) to close annulus 202 and maintain pressure in annulus 202 during drilling operations. In the illustrated example of FIG. 2, RCD 106 includes dual seal elements 210. The two seal elements 210 can have the same size, configuration, or property; or the two seal elements 210 can be different. For example, one or both of the seal elements be a self-lubricating seal element that includes self-lubricating components in the seal material. The two seal elements 210 may include the same type of self-lubricating components with the same concentration, or the two seal elements 210 can include different self-lubricating components with different concentrations. The self-lubricating components can be added into the seal elements 210 based on specific applications or system requirements to optimize the performance and operable life of the whole RCD 106.

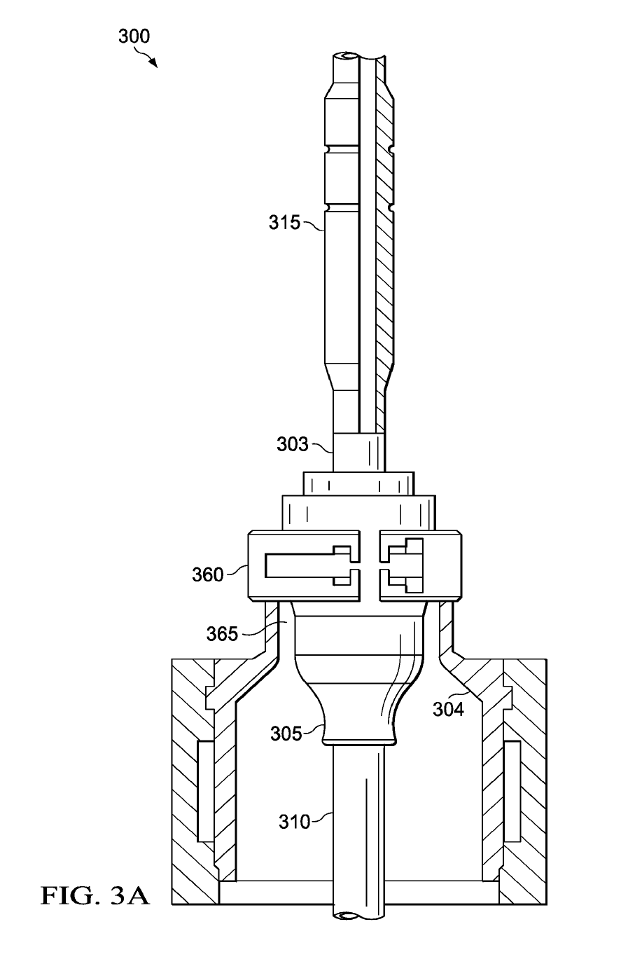

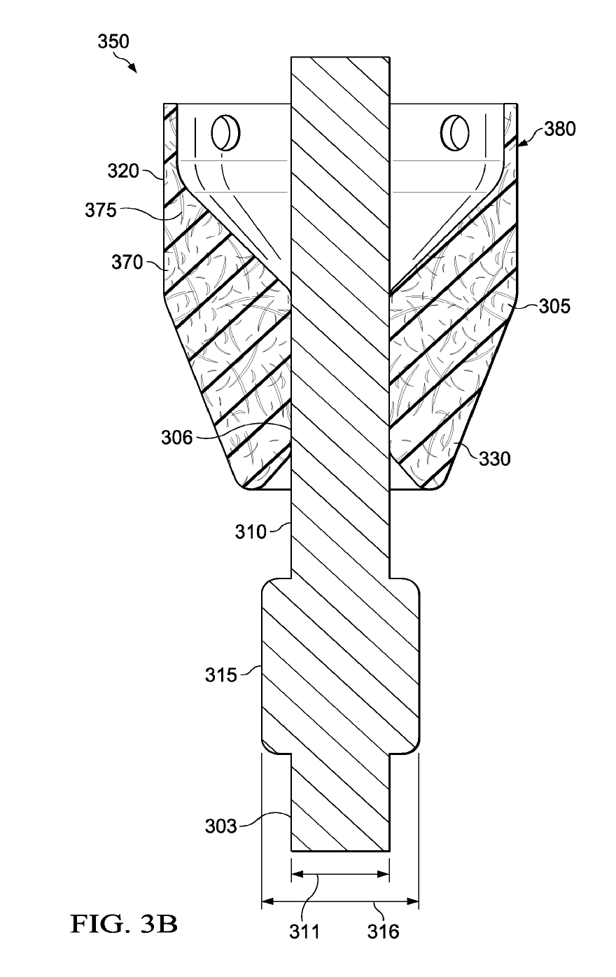

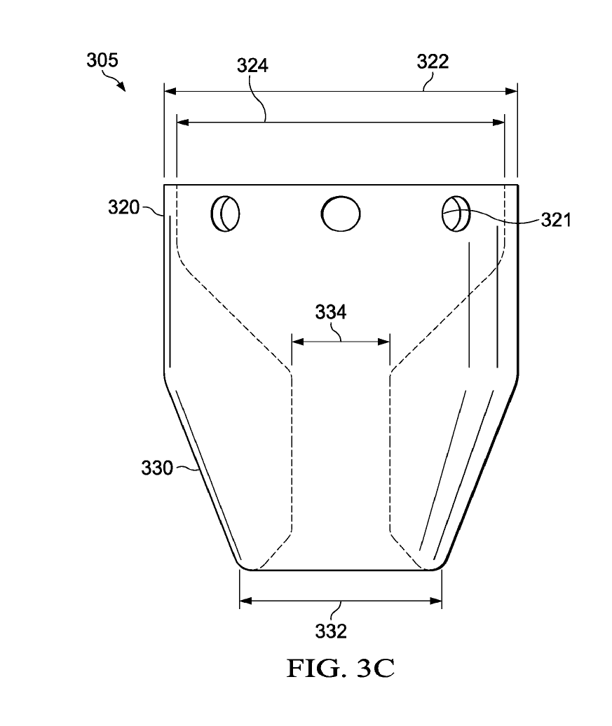

FIG. 3A is a cross section view of another example RCD 300. RCD 300 can be used as the example RCD 106 in FIGS. 1 and 2 or RCD 300 can be used in another manner. While the example RCD 106 in FIG. 2 includes dual seal elements 210, RCD 300 includes a single seal element 305. Seal element 305 is located within the body or housing 304 of RCD 300. Latch assembly 360 (e.g., a hydraulic clamp) secures RCD seal element 305 inside the housing 304 and facilitates installation, removal, or replacement of seal element 305. RCD seal element 305 acts as a passive seal that maintains a constant barrier between the atmosphere above and wellbore below. Drill string 310 extends from a drilling rig (not shown) through the seal element 305 and into the wellbore (not shown) RCD seal element 305 seals around the drill string 310 (or other tubular used to convey a drilling, or completion, or well fracturing, or other Bottom Hole Assembly (BHA)) thus “closing” the annulus. In some implementations, the RCD seal element rotates with the drill string, and in some other implementations, the RCD seal element remains stationary while the drill string rotates within.

A drill string typically includes multiple tubular members commonly known as joints of drill pipe connected by threaded connections located on both ends of the drill pipes. Although the threaded connections (referred to in the art as “tool joints”) may be flush with outer diameter of the drill pipes, they generally have a wider outer diameter. As illustrated, drill string 310 is formed of a long string of threaded pipes 303 joined together with tool joints 315. Drill string 310 can pass through seal element 305 with rotation, reciprocation, or both. In some implementations, more reciprocation can be involved during drill operations than rotation. Seal element 305 can accommodate the change of the outer diameter of drill string 310, for example, via expansion and relaxation. For example, as shown in FIG. 3A, there is spacing 365 between the outer surface of seal element 305 and the inner surface of RCD body 304 and the seal element can expand outwards to let through tool joints 315 of a wider outer diameter. A seal element can accommodate both a rotating drill sting and a non-rotating drill string with tool joint drill string through the bore of the seal element. In the illustrated example in FIG. 3A, drill pipe 303 is passing through the bore in seal element 305 while tool joint 315 is about to pass through seal element 305. While much of this description has discussed drill strings with drilling BHA's being run through RCD's those skilled in the art will recognize that other types of strings may be run under closed annulus pressure and be sealed against by the RCD and its various types of sealing elements. Other types of string include but are not limited to completion strings containing production tubing and completion devices, well fracturing drill strings comprising drill pipe or production tubulars and downhole packer equipment, gravel pack strings comprising drill pipe or production tubing and gravel pack equipment and casing strings or liners.

FIG. 3B is a cross section view 350 of the example rotating control device (RCD) 300 without RCD housing 304. As illustrated, tool joint 315 passed through the bore in seal element 305 defined by inner surface 306 of seal element 305 and inner surface 306 seals against drill string 310. Tool joints 315 have an outer diameter 316 that is larger than the outer diameter 311 of drill pipes 303. As drill string 310 is longitudinally translated through the wellbore and the RCD 300, the RCD seal element 305 squeezes against an outer surface of the drill string 310, thereby sealing the wellbore. In particular, the inner diameter of the RCD seal element 305 is smaller than the outer diameter of the items passed through (e.g., drill pipes, tool joints) to ensure sealing.

FIG. 3C is a side view of RCD seal element 305 in FIG. 3B. RCD seal element 305 has a base end 320 and a nose end 330. The base end 320 is typically attached to a mandrel (not shown) running through the center of the bearing assembly, however it could also be attached to a stripper housing that does not include a bearing. The mandrel is attached to the bearing housing via two sets of bearings. The element is then screwed onto the mandrel or bolted to the mandrel; this allows the element to rotate with the drill string during drilling operations. For example, holes 321 are provided for set screws to lock the element to the mandrel once the element has been threaded onto the mandrel. There are multiple other techniques used to mount the RCD seal element to the RCD. This disclosure shall not be limited to this style of core but rather encompass all styles of core.

The nose end 330 has an inner diameter 334 that is smaller than the inner diameter of the base end 320 to provide a tight seal against the drill string 310. The outer diameter 322 of the base end 320 may be larger than the outer diameter 332 of the nose end 330. Similarly the inner diameter 324 of the base end 320 may be larger than the inner diameter 334 of the nose end 330.

An RCD seal element may be a molded device that is often made from of an elastic material which is flexible enough to deform to fit around and seal the varying diameters. Seal element material may include but not be limited to natural rubber, nitrile rubber, nitrile, butyl or hydrogenated nitrile, urethane, polyurethane, fluorocarbon, perflurocarbon, propylene, neoprene, hydrin, for example, and depends on the type of drilling operation. For instance, RCD seal element 305 of the present disclosure can be made from an elastomer 370 and is flexible enough to deform to fit around and seal the varying diameters of drill pipe 310 (e.g., diameters 311 and 316 shown in FIG. 3B), for example, during reciprocation of drill string 310.

During drilling operations, seal element (e.g., seal element 210 or 305) and the bearings (not expressly shown) of bearing assembly (e.g., bearing assembly 206) may experience wear due to rotation and reciprocation of drill string (e.g., drill string 104 or 310). To alter the performance characteristics of various RCD seal element body materials, the addition of self-lubricating component of many kinds and sizes may be used. Self-lubricating components may include, but are not limited to, polarized graphite, calcium stearate, flurons, PTFE solid powder, graphene/few-layered graphene (e.g., 1 to ˜12 atomic layers of SP2 carbon), graphene oxide (e.g., chemically exfoliated and functionalized graphite layers), hexagonal boron nitride (h-BN, e.g., same structure as graphite but with alternating B and N atoms with improved oxidation resistance at any temperature (e.g., at high temperatures above 200° C.)), intermediate compositions (e.g., boron-doped graphene and graphite, nitrogen-doped graphene and graphite, and carbon-doped h-BN/B&N co-doped graphene), multi-walled carbon nanotubes where the break-down product is fragments of graphene/few-layered graphene, or a combination thereof. Other compositions with layered structures such as chalcogenides (MoS2, WS2, NbS2, TaS2, VS2, ReS2, MoSe2, WSe2) could also be utilized as a lubricating phase within the elastomer material. The self-lubricating components can be fibers, particles, nanotubes, or in other forms. The self-lubricating components may be of varying deniers, lengths, diameters, sizes, shapes, or other properties. For example, a self-lubricating component may include fibers of uniform length and varying denier or a self-lubricating component may include particles of uniform shape and varying size. Other combinations are permissible.

The materials would be envisioned to impart lubricity to the contact areas of the tool as well as improved mechanical and thermal stability and thermal conductivity to elastomers. The materials could be incorporated as solid powders or slurries during the elastomer compounding process, incorporated as a dispersion or solution in a liquid state during compounding or crosslinking, or incorporated in another manner.

As shown in FIG. 3B, self-lubricating components 375 can be added to the elastomer raw material 370 to form a resultant composite material 380 for RCD seal element 305. This composite material 380 can be comprised of both uniformly distributed and non-uniformly distributed self-lubricating components. Self-lubricating components 375 can be randomly oriented, or may be non-randomly oriented (i.e., oriented radially, oriented longitudinally, or oriented at some other angle or combination of angles).

The concentration of self-lubricating components 375 within the elastomer material 370 can be varied to alter the properties of the composite material 380, allowing for the customization of element material properties. For example, an RCD seal element may be molded with an elastomer that has a uniform concentration of self-lubricating components throughout. Any component concentration is permissible. In some implementations, the concentration of self-lubricating components (e.g., polarized graphite) can be in a range of approximately 7% to 25% by volume, for example, depending on an application and environment the seal element or packer will be exposed to. As the seal element or packer is worn away at the seal element or packer/drill pipe (or other tubular) interface, flakes of the self-lubricating components are released lubricating the seal interface and reducing wear.

Alternatively, an RCD seal element may be molded with an elastomer material that has a non-uniform concentration of self-lubricating components along the length (i.e., along a longitudinal or axial axis) of the RCD seal element. For example, an RCD seal element can have a higher concentration of self-lubricating components at its base 320 and a lower concentration of self-lubricating components at its nose 330. Any combination of component concentration is permissible. In some instances, more than two concentrations (i.e., three different self-lubricating component concentrations) can be used. For example, a seal element can have a region with high concentrations of self-lubricating components, a region with moderate concentrations of self-lubricating components and a region with low concentrations of self-lubricating components. In some implementations, in a varying self-lubricating component concentration RCD seal element, the self-lubricating component concentration at different regions can be selected to optimize performance of the different regions of the RCD seal element. As an example, a particular region (e.g., the nose end 330) may have a higher self-lubricating component concentration if the particular region is subject to more friction and wear than other regions. Additional or different configurations associated with the self-lubricating components can be designed.

To fabricate an RCD seal element of the present disclosure, one or more raw elastomer materials are prepared. Once prepared, the elastomer is molded around a core to form a complete RCD seal element. The element can be made from cast polyurethane, which uses a mold with a core. The core is used to form the inside diameter (“ID”) of the element. The RCD seal element has a steel cage or core molded into its base. RCD seal elements can be molded using a single elastomer with a uniform self-lubricating component concentration, or using multiple combinations of elastomers with various self-lubricating component concentrations, or no self-lubricating components at all. For example, an element may be molded with a high self-lubricating component concentration region at its base which transitions into a region of low self-lubricating component concentration in its middle which transitions into a region of no self-lubricating component concentration at its nose. Likewise, elements may be molded with various combinations of elastomer with the same amount of self-lubricating component concentration. For example, an element may be molded with a region of low durometer elastomer and a region of high durometer elastomer, both with equal amounts of self-lubricating components. Any combination of elastomer and self-lubricating components is permissible.

In some implementations, the base elastomeric material in the elastomer to mold an RCD seal element can be selected from a group of natural rubber, nitrile rubber, hydrogenated nitrite, urethane, polyurethane, fluorocarbon, perflurocarbon, propylene, neoprene, hydrin, or a combination thereof in some instances, the base elastomeric material can constitute approximately from 50% to 99% by volume in the composite elastomer. In some instances, the base material in the elastomer being used to mold an RCD seal element is primarily polyurethane. Polyurethane may be used in any combination with natural rubber, nitrile, or butyl. Polyurethane is a flexible elastomer that can be stretched over the changing outer diameter of drill pipe and tool joints. To form an RCD seal element of the current disclosure, the polyurethane is cast by pouring polyurethane in a liquid state into a mold.

To create a self-lubricating RCD seal element, self-lubricating components (e.g., polarized graphite) are mixed into the liquid state elastomer (e.g., polyurethane). The mixture is poured into the mold. Heat and time are then applied to allow the material to set by heating in a curing oven. The formed seal element has a longitudinal bore, through which both a rotating drill sting and a non-rotating drill string with tool joint thereon can pass. In some instances, the seal element is fabricated such that the self-lubricating compound is (evenly) distributed throughout the entire seal element. In some instances, the seal element can be fabricated such that the self-lubricating compound is only distributed in the wall section adjacent to the drill pipe. In some instances, the seal element can be fabricated such that the mixture of the self-lubricating component and the liquid elastomer is adjacent to at least an inner circumferential surface of the longitudinal bore of the seal element. The mixture of the self-lubricating component and the liquid elastomer can fill a portion of the seal element extending outward radially from an upper end of the longitudinal bore to a lower end of the longitudinal bore of the seal element. As a specific example, the seal element can have at least a portion adjacent to and within 2 centimeter radially of an inner circumferential surface of the bore that contains the self-lubricating component and wherein the mixture of the self-lubricating component and the liquid elastomer fills a portion of the seal element extending outward radially from an upper end of the longitudinal bore to a lower end of the longitudinal bore of the seal element. The distribution of the self-lubricating components can be fabricated in another manner.

In one example implementation, self-lubricating components are added to the liquid elastomer and the mixture poured into the mold results in a uniform distribution of self-lubricating components with random orientation.

In another example implementation, the self-lubricating components are longitudinally suspended from the top of the mold so that they hang down throughout the length of the element running parallel to the central axis of the element. When the mold is filled the elastomer will fill in around the suspended self-lubricating components and cure with the self-lubricating components inside of the element.

In another example longitudinal channels running from the base (top) to the nose (bottom) and running parallel to the central axis of the element are left in the base material in the initial molding process. The channels are later filled with the selected self-lubricating compound in a second molding process.

In a further example implementation, the self-lubricating components are connected to the mold core and extended to the mold shell. This would orient the self-lubricating components in a radial direction. Again the mold would be filled and the elastomer allowed to cure.

Another example implementation involves filling the mold with the liquid elastomer and then inserting the self-lubricating components into the liquid with an insertion tool. In some instances, the elastomer (e.g., polyurethane) is a highly viscous fluid when it is poured into the mold, a self-lubricating component could be inserted and once released it would stay in the location it was deposited. Self-lubricating components could be inserted in any orientation and concentration desired.

Concentration and placement of the self-lubricating component in elastomers containing polyurethane can be carefully controlled, thus allowing regions of the element to be targeted with more self-lubricating components and other regions to be given very little or no self-lubricating components. To create an element with targeted regions of self-lubricating component concentrations, multiple batches of liquid elastomer with different amount of self-lubricating components are mixed. When filling the RCD seal element cast, the appropriate mixture would be used to fill the portion of the cast that is being target for a specific self-lubricating component concentration. For example, after placing a first elastomer material having a first concentration of self-lubricating components, a second elastomer material having a second concentration of self-lubricating components can be placed into the mold.

Although the above mentioned examples are described as having two separate portions, wherein each separate portion has a different self-lubricating component concentration, it is also within the scope of the present disclosure for the at least two elastomer materials to partially mix. For example, approximately a 0.5″-1″ region of mixing can exist between layers. In some implementations, the region of mixing can be about 0.25″ to about 0.5″. Alternatively, the region that experiences mixing could be increased.

As an example use of a self-lubricating RCD seal element in rotary drilling systems, the self-lubricating seal element is held inside the RCD. The RCD is positioned at an upper proximal end of a wellbore, for example, as shown in FIG. 1. RCD has a housing configured to receive a seal element molded from elastomer and a self-lubricating component mixed into at least a portion of the elastomer. In some implementations, the outer surface of a seal element does not need to conform with the inner surface of the RCD housing so that there is room for expansion and relaxation of the seal element to accommodate drill strings with different sizes.

A drill pipe can be stabbed (passed) through a bore extending axially through the seal element. The bore is sized to seal against and allow passage through the bore of an outside diameter of the drill pipe and a tool joint having a larger outside diameter in the housing of the RCD. In some instances, a drill string can be a tapered drill string (e.g., smaller outside diameter (“OD”) pipe on the bottom, larger OD pipe on the top). The RCD can be only required to seal on the larger pipe, not the entire string. In particular, when the drill pipe enters the RCD, the inner surface of the seal element seals against the drill pipe and deforms the inner diameter of the RCD seal element to fit over the larger diameter of the drill pipe. An interfacial seal is created which is capable of separating the high pressure region of the wellbore from the atmospheric pressure region of the rig floor. The seal element can maintain a pressure seal between the seal element and the drill pipe wherein a pressure in the wellbore below the RCD is greater than the ambient pressure outside the RCD. While attached, the drill pipe penetrating the RCD seal element is capable of vertical motion as well as rotational motion. The RCD seal element is also able to expand to fit over tool joints as new sections of drill pipe are added to the drill string. The drill string comprised of multiple joints of drill pipe can pass through the bore of the seal element. In some implementations, the drill string can be rotated and the pressure seal can be maintained while passing the rotating drill string through the bore of the seal element. During this process, the self-lubricating seal element releases self-lubricating components and lubricates the contact surfaces between the drill string and the seal element. Friction and wear can be reduced and the durability of the seal element can be improved.

In some implementations, although the tubular passing through the RCD and being sealed against is primarily the drill string, the tubular could also be a completion string comprising production tubing, fracturing string comprising drill pipe or production tubing, gravel pack string comprising drill pipe or production tubing, casing string or liner, or another type. In this disclosure, the term “string” is used to encompass all possible types of tubulars that can be passed through the RCD.

A number of embodiments of the disclosure have been described. Nevertheless, it will be understood that various modifications may be made without departing from the spirit and scope of the disclosure. Accordingly, other embodiments are within the scope of the following claims.

1. A method for making a seal element for a rotating control device used in rotary drilling systems, said method comprising:
providing a mold for the seal element for the rotating control device;
adding at least one self-lubricating component to a liquid elastomer;
placing the liquid elastomer having self-lubricating component into the mold;
curing the combined elastomer and self-lubricating component in the mold; and
forming a seal element having a base region, a nose region opposite the base region, and a longitudinal bore being adapted to sealingly pass therethrough said bore in a non-rotating and a rotating mode of operation a tool string with at least one tubular member and at least one tool joint having a greater outside diameter than an outside diameter of the tubular member, and said seal element being adapted to lubricate with the self-lubricating component in the seal element the tool joint as it sealingly passes through the longitudinal bore of the seal element.

2. The method of claim 1, wherein curing the combined elastomer and self-lubricating component in the mold comprising heating the combined elastomer and self-lubricating component in the mold.

3. The method of claim 1, wherein adding the at least one self-lubricating component comprises placing polarized graphite in the liquid elastomer.

4. The method of claim 3 wherein placing the polarized graphite comprises placing approximately 7% to 25% polarized graphite as measured by total volume of the portion of the seal element containing self-lubricating component.

5. The method of claim 1 further comprising placing an elastomer material having a second concentration of self-lubricating components into the mold.

6. The method of claim 1 comprises selecting self-lubricating components from the group consisting of calcium stearate, flurons, PTFE solid powder, graphene, few-layered graphene, graphene oxide, hexagonal boron nitride, boron-doped graphene and graphite, nitrogen-doped graphene and graphite, carbon-doped h-BN/B&N co-doped graphene, multi-walled carbon nanotubes, and chalcogenides.

7. The method of claim 1 wherein placing an elastomer comprises further comprising selecting an elastomer from the group consisting of natural rubber, nitrile rubber, hydrogenated nitrile, urethane, polyurethane, fluorocarbon, perflurocarbon, propylene, neoprene and hydrin.

8. The method of claim 7 wherein placing the elastomer comprises placing 75 to 99% of at least one of the compounds of the group of claim 6 as measured by total volume of the seal element.

9. The method of claim 1 further comprises placing the self-lubricating component into the liquid elastomer with an insertion tool.

10. The method of claim 1 wherein the self-lubricating component is added to the liquid elastomer and then placed in the mold such that a mixture of the self-lubricating component and the liquid elastomer is adjacent to at least an inner circumferential surface of the longitudinal bore of the seal element and extends radially inwardly into the seal element away from the inner circumferential surface of the bore at least 2 centimeters.

11. The method of claim 10, wherein the mixture of the self-lubricating component and the liquid elastomer fills a portion of the seal element extending outward radially from an upper end of the longitudinal bore to a lower end of the longitudinal bore of the seal element.

12. (canceled)

13. A seal element for a rotating control device used in rotary drilling systems said seal element comprising:
a seal element molded from elastomer and a self-lubricating component mixed into at least a portion of the elastomer;
said seal element having an inner surface, which defines a longitudinal bore extending axially through the seal element, said longitudinal bore being adapted to sealingly pass therethrough said bore in a non-rotating and a rotating mode of operation a tool string with at least one tubular member and at least one tool joint having a greater outside diameter than an outside diameter of the tubular member; and
said seal element further being adapted to lubricate with the self-lubricating component in the seal element the tool joint as it sealingly passes through the longitudinal bore of the seal element.

14. The element of claim 13 wherein a mixture of the self-lubricating component and the elastomer is adjacent to at least an inner circumferential surface of the longitudinal bore of the seal element and extends radially inwardly into the seal element away from the inner circumferential surface of the bore at least 2 centimeters.

15. The element of claim 14 wherein the mixture of the self-lubricating component and the elastomer fills a portion of the seal element extending outward radially from an upper end of the longitudinal bore to a lower end of the longitudinal bore of the seal element.

16. The element of claim 13, wherein the self-lubricating component comprises polarized graphite.

17. The element of claim 16 the polarized graphite comprises approximately 7% to 25% polarized graphite as measured by total volume of the portion of the seal element containing self-lubricating additives.

18. The element of claim 13 wherein the self-lubricating component is selected from the group consisting of calcium stearate, flurons, PTFE solid powder, graphene, few-layered graphene, graphene oxide, hexagonal boron nitride, boron-doped graphene and graphite, nitrogen-doped graphene and graphite, carbon-doped h-BN/B&N co-doped graphene, multi-walled carbon nanotubes, and chalcogenides.

19. The element of claim 13 wherein the elastomer is selected from the group consisting of natural rubber, nitrile rubber, hydrogenated nitrile, urethane, polyurethane, fluorocarbon, perflurocarbon, propylene, neoprene and hydrin.

20. The element of claim 19 wherein elastomer comprises 75 to 99% of at least one of the compounds of the group of claim 19 as measured by total volume of the seal element.

21. A method of using a seal element for a rotating control device used in rotary drilling systems; said method comprising:
positioning a rotating control device (RCD) at an upper proximal end of a wellbore;
said RCD having a housing configured to receive a seal element molded from elastomer and a self-lubricating component mixed into at least a portion of the elastomer;
placing said seal element in the housing of the RCD, said seal element having an inner surface which defines a longitudinal bore extending axially through the seal element, said bore adapted to seal against and allow passage through the longitudinal bore of an outside circumferential surface of a tubular member and a circumferential surface of a tool joint wherein the tool joint has a larger outside diameter than the tubular member in the housing of the RCD;
passing a tubular string comprised of a plurality of the tubular members and the tool joints through the bore of the seal element;
maintaining a pressure seal between the seal element and the tubular string wherein a pressure in the wellbore below the RCD is greater than the ambient pressure outside the RCD while passing the tubular string through the bore of the seal element;
rotating the tubular string and maintaining the pressure seal while passing the rotating tubular string through the bore of the seal element; and
lubricating the contact surfaces between the string and the seal element with the self-lubricating component of the seal element as the string is passed through the longitudinal bore of the seal element in a rotating an non-rotating mode.

22. The method of claim 21 wherein a mixture of the self-lubricating component and the elastomer is adjacent to at least an inner circumferential surface of the longitudinal bore of the seal element and extends radially inwardly into the seal element away from the inner circumferential surface of the bore at least 2 centimeters.

23. The method of claim 22 wherein the mixture of the self-lubricating component and the elastomer fills a portion of the seal element extending outward radially from an upper end of the longitudinal bore to a lower end of the longitudinal bore of the seal element.

24. The method of claim 21, wherein the self-lubricating component comprises polarized graphite.

25. The method of claim 24 wherein the polarized graphite comprises approximately 7% to 25% polarized graphite as measured by total volume of the portion of the seal element containing self-lubricating additives.

26. The method of claim 21 wherein the self-lubricating component is selected from the group consisting of calcium stearate, flurons, PTFE solid powder, graphene, few-layered graphene, graphene oxide, hexagonal boron nitride, boron-doped graphene and graphite, nitrogen-doped graphene and graphite, carbon-doped h-BN/B&N co-doped graphene, multi-walled carbon nanotubes, and chalcogenides.

27. The method of claim 21 wherein the elastomer is selected from the group consisting of natural rubber, nitrile rubber, hydrogenated nitrile, urethane, polyurethane, fluorocarbon, perflurocarbon, propylene, neoprene and hydrin.

28. The method of claim 27 wherein the elastomer comprises 75 to 99% of at least one of the compounds of the group of claim 27 as measured by total volume of the seal element.
